(19) United States
(12) Patent Application Publication
(10) Pub. No.: US 2014/0143142 A1
(43) Pub. Date: May 22, 2014

(54) Electronic Currency System

(71) Applicant: Albert I. Talker, Westfield, NJ (US)

(72) Inventor: Albert I. Talker, Westfield, NJ (US)

(21) Appl. No.: 13/792,075

(22) Filed: Mar. 10, 2013

Related U.S. Application Data
(63) Continuation-in-part of application No. 12/983,890, filed on Jan. 4, 2011, now abandoned.
Application No. 12/983,890 is a continuation-in-part of application No. 09/793,040, filed on Feb. 26, 2001, now Pat. No. 6,954,740.

(51) Int. Cl. G06Q 20/36

(52) U.S. Cl. CPC G06Q 20/36
USPC 705/41

(57) ABSTRACT

An electronic currency system having Currency Issuing Authorities that are coupled to a money generator device for generating and issuing to subscribing customers electronic currency backed by correspondent Currency Issuing Authorities and participating Financial Institutions that accept and distribute the electronic money; a plurality of devices that are used by subscribers for storing electronic money and for performing money transactions with other participants and participating Currency Issuing Authorities and Authorized Financial Institutions, for exchanging electronic money with other like transactions; and verification arrangement for maintaining the integrity of the system, and for detecting counterfeiting and tampering within the system. The electronic currency consists of data in a form suitable to be stored in a participant's data storage medium, comprising information on the currency value, authentication values, certificate chain, and identification of the participants' devices.

### FIELD OF THE INVENTION

The invention relates to electronic currency. More particularly, the invention relates to electronic cash money, to electronic wallets carrying such cash money, and to electronic payment systems employing them.

### BACKGROUND OF THE INVENTION

Electronic payment transactions have become increasingly important, and tremendous efforts are constantly placed into the development of suitable systems for carrying out such transactions. One such system is the so-called “electronic wallet” or “electronic purse”, which holds sums of money withdrawn from a bank, which can be used to pay for goods and services. The electronic wallet presents several problems which, so far, have limited its use. It further presents a disadvantage that renders it unattractive for many persons, namely, it causes a loss of feeling of control over the money it contains and require an online connection and a central server for verification and authentication. Since all procedures are automated, encrypted and electronic, with only minimal intervention of the owner, many owners feel that they have no real control over the movement of their money.

Estimated global demand for electronic money continues to increase and is expected to exceed several billion dollars within the next few decades. Here, electronic money or e-money refers to digital currency and electronic payments that exist only in an electronic state.

Electronic cash has many applications, ranging from the use of electronic wallets carried on the owner, in lieu of credit cards, in daily transactions and including payments for goods and services purchased over the Internet. The problem of payments over the Internet is well known, and many solutions to it have been suggested. The problem is a complicated one, because the use of credit cards over the Internet is unsafe, and because in many transactions the buyer does not wish to provide details of himself, or of his bank account.

Among the systems suggested to overcome this problem, there can be mentioned a few. For instance, a concept called “First Virtual” first asks a potential customer to fill out an application form providing standard personal information. First Virtual would then send a personal identification number (PIN) with an 800 number over the Internet to the customer's email. Then the customer is supposed to use the 800 number to give the customer's credit card information over the phone to First Virtual to establish or open no more than just an electronic charge account.

Another concept called “Cybercash” requires customers or buyers on the Internet to first open a special Cybercash bank account that contains money designated for spending on the Internet. A consumer issues instructions to purchase goods or services on the Internet and money for these items are transferred from the consumer's Cybercash bank account to that of the merchant's. Transactions are anonymous unless the seller specifically asks for the identity of the buyer.

Yet another concept called the “Netbill” requires a buyer on the Internet to first put money in a Netbill account and subsequent transactions made by the buyer are to be drawn off from the account sum or balance. Accounts of both buyers and sellers are maintained on a Netbill server, to keep transactions off the Internet and to maintain lower transaction costs. After a purchase is made, the transfer of funds will automatically take place at the server. Digital goods, e.g. programs, documents etc. are transferred to the buyer in encrypted form. When the Netbill account has cleared the transaction, a receipt containing the key to the encrypted goods is sent to the merchant, then forwarded to the consumer.

A two-step process called “Millicent” had also been introduced, using fake money. A merchant creates its own electronic currency, or “scrip”, that is sold to brokers. Brokers then sell the scrip to buyers. Sellers deal with just a handful of accounts, spreading transaction costs over a large volume of purchases. Millicent customers need to buy currency from only a few trusted brokers.

Another system is the so-called “Digicash” or “ecash”. In theory this system turns a user's or buyer's hard drive on a PC into a purse. To use this system, one first establishes an account with a bank. To obtain digicash or ecash, the user creates a series of numbers that will represent a mixture of coins or money bills in various denominations according to the user's own wishes. This request for digicash is then sent to the bank, which deducts the total amount requested from the user's existing valid account. The bank then sends the user an equivalent amount of ecash as an encrypted email message containing a series of numbers. Each number corresponds to a specified amount of money. Before the user can actually use these encrypted series of numbers from the bank to purchase goods or services on the Net, the user must first obtain a user name and a password from Digicash. Then the user has to download Digicash's ecash software to the user's PC. The final step is to create the user's own encryption key (in essence another password) and together with the user's password obtained earlier from Digicash, the user can then spend ecash on the Net.

Another system that has been suggested is the PayMe system (Michael Peirce and Donal O'Mahony, “Scaleable, Secure Cash Payment for WWW Resources with the PayMe Protocol Set”, presented at the Fourth International World Wide Web Conference, Dec. 11-14, 1995, Boston, Mass., USA—http://www.w3.org/Conferences/WWW4/Papers/2281). PayMe is an on-line electronic cash system. The entities involved are banks and users. Users can be either buyers or merchants but each has the same functionality. They can make payments, accept payments, or deal with the bank. Each bank mints its own identified electronic cash with serial numbers. Double spending of coins is prevented by the bank maintaining a database of coins in circulation. Any user in the PayMe system can accept payments and make payments. Merchants can receive payments for selling Web goods but they can also make payments to the buyers. This can be used for making refunds or in pay-out services.

Coins are the pieces of data that represent monetary value within the system. The coins are digitally signed by the bank using public key cryptography to make them valid currency. Each coin has a serial number which is entered into the bank's database when the coin is minted. Coins have fields for the coin value, serial number, bank id, bank host name and port number, and expiry date. When these five fields are put together and signed with the bank's private key, a valid coin is created.

PayMe can be used with any Web client or server. To purchase an item a user starts up both their PayMe Wallet and any Web client. They browse the Web until they find a merchant shop, which will be presented by a HTML document.

Mobile device penetration is one reason for this increased electronic money demand. In the underdeveloped world, for example, a majority of the population can access mobile handsets. In fact, such mobile communication devices bridge the financial divide for the so called “unbanked population” without checking accounts by allowing them to use mobile devices to execute monetary transactions. For example, a mobile phone subscriber can prepay for services by depositing cash with an MNO (Mobile Network Operator); and use such credit for payment of purchased goods or services.

Mobile money does constitute pseudo currency that is a substitute for money. For example, a mobile subscriber can use top-up minutes or transfer top-up minutes to another mobile subscriber in exchange for goods and services purchased by the first mobile subscriber.

Such mobile money is, however, proliferating without involvement of central banks Among other functions, central banks typically issue currency and implement monetary policies as well. Since pseudo currencies are issued by private nonfinancial entities, such pseudo-currencies only work within “closed systems” such as within a mobile network operating system and are not available for use outside of the closed system. Thus, unlike cash issued by the central bank, interoperability is difficult and valuation of such pseudo currencies remains questionable.

Central banks are concerned about consumer protection and are also wary about issuance of electronic money by non-financial institutions due to inadequate capitalization by such institutions, loss of consumer deposits, potential for destabilizing the money supply balance and lack of transparency of electronic payment transactions both for domestic and international cross-border electronic transactions.

All the aforementioned systems require a direct interaction between the seller and the buyer during the transfer of the payment and require a central server for authentication of the electronic cash.

Another severe drawback of certain systems is that it does not allow transfer from one mobile device to another mobile without the involvement of the internet and another central server.

Another severe drawback of certain systems is that they require that the cash dispenser be involved in the transaction, to identify the users (either the buyer, the seller, or both), rendering the transaction cumbersome, and detracting from its privacy.

Another severe drawback of certain systems is that they require that authentication server will be always present and that transactions always needed to be conducted online.

Another severe drawback of certain systems is that they do not allow the transfer of electronic cash between participants and always require a third party server to manage the transactions.

Another severe drawback of certain systems is that they do not allow the user to view his electronic cash graphically as cash notes with authentication info on the notes.

Because, of these facts, there is currently no electronic “currency” that can be used in a simple manner by the general public as well as by Internet surfers, just as one uses bills, coins or checks. For this reason, e-commerce is still relatively limited both in physical transactions, such as in shops and in service-providing establishments, and over the Internet. It is therefore clear that there is a great need for an electronic currency that overcomes the disadvantages of the prior art. The prior art does not take into account that most transactions made over the Internet or other LANs or WANs involve small sums. While it is important to ascertain that theft of such sums is made difficult, just as one keeps his pocket money, the danger of theft does not justify the complexity of the systems devised by the prior art, nor they justify or constant authentication means by central authentication server that keeps tracks of issued, spent and authenticate notes.

Additionally, and largely because of said misconception, most of the prior art systems require the user to open an account with either a bank, or a pseudo-bank, or with a supplier, and either to provide prepaid funds to these accounts, from which it possible to draw, or to perform relatively complicated operations when the user wishes to spend, withdraw or generate funds.

Because, of these facts, there is currently no electronic “currency” that can be used in a simple manner by the general public in physical transactions or when surfing the Internet, just as one uses bills, coins or checks. For this reason, e-commerce is still relatively limited in physical shops and over the Internet.

It is therefore clear that it would be highly desirable to provide an electronic currency system which is free from all the aforementioned drawbacks, and which permits commerce and e-commerce to proceed freely, in a manner as similar as possible to live commerce.

It is therefore an object of this invention to provide electronic currency and a system for its implementation, that overcome all the aforementioned drawbacks of the prior art.

It is another purpose of this invention to provide electronic currency that can be converted to and from regular currency, and which can be transferred in real time from one Internet user to another.

It is a further purpose of the invention to provide an electronic currency and system which are user-independent, and which do not require a user key or user identification, such currency being essentially “to the bearer”.

It is yet another object of the invention to provide electronic currency in electronic form that can be lawfully copied onto magnetic, optical or other media, so as to ensure against loss or crashes of the media where the currency is saved.

It is a further object of the invention to provide electronic money and systems employing it, which can be used for carrying out transactions over the Internet.

It is a further object of the invention to provide a method and currency which can be used for the simultaneous service receipt/payment, and which can further be used for payments which are linked to the quantity of goods or services electronically furnished.

Other purposes and advantages of this invention will appear as the description proceeds.

### SUMMARY OF THE INVENTION

To achieve the foregoing, and other objects, the method and system of the present invention employ a preferred embodiment in the form of an electronic-monetary system having (1) Currency Issuing Authority coupled to a electronic money generator servers for generating and issuing to participants electronic money including electronic currency backed by deposits and credits kept in correspondent banks that accept and distribute the electronic money; (2) a plurality of transaction devices that are used by participants for storing electronic money, for performing money transactions with the on-line systems of the participating banks or for exchanging electronic money with other like transaction devices in off-line transactions; (3) a data communications means for providing communications services to all components of the system; and (4) a security arrangement and verification means for maintaining the integrity of the system, and for detecting counterfeiting and tampering within the system.

The system of the invention will be referred to herein as “The System”, for the sake of brevity. It resembles in many features the monetary system of a country, in which there is a currency issuing authority (CIA) that issues currency (bills, coins or money orders) to individuals. The CIA is based on distributed servers where issued currency tokens can be exchanged for a funding transaction from a participating bank.

The CIA is not involved in the transactions carried out with the currency it issued, but is responsible for the value of the currency and for its maintenance. The CIA continuously examines the currency circulating on the market, replaces Payment Tokens, issues new currency Tokens as needed, and refuses to honor counterfeit currency.

According to The System, a CIA also exists, which functions in a similar manner, but with many improvements and with the differences that will be explained in detail below. The CIA may be a country or an organization within it, or a financial or other organization. As with the treasury of a country, the basic condition for a currency to be of value is the solvency of the CIA or of the organization it represents. There is no limitation on the number of CIAs that may issue electronic currency, and just as with countries, exchange rates can be established between different currencies issued by different CIAs. A CIA may be electronically connected with multiple of financial organizations (banks) where issuance of electronic currency could be delivered to be distributed to the participants of the system via the financial organizations.

The Payment Tokens (electronic money) exchanged by the different participants of the System may be an electronic representation of currency or credit. An important aspect of the Payment Tokens is that it is the equivalent of bank notes and is interchangeable with conventional paper money through claims on deposits in a participating bank, but can be withdrawn or deposited both at an issuing CIA and at a participating bank.

The electronic money representations are fungible, universally accepted, and undeniably redeemable from the issuing banks, i.e., they have the characteristics of money transactions. To preserve the integrity of the electronic monetary system, each exchange of electronic money includes, along with other information, data identifying the monetary unit of the credit or currency, (i.e., dollars, yen, etc.) the amount by unit of credit or currency, and several digital signatures.

The electronic money exchanged by these devices of the different participants of the System may be an electronic representation of currency or credit. An important aspect of the electronic currency is that it is the equivalent of bank notes and is interchangeable with conventional paper money through claims on deposits in an issuing bank.

In the main embodiment of the present invention, the system includes a Currency Issuing Authority coupled to a money generator device for generating and issuing to subscribing participants electronic money (Payment Tokens) backed by deposits or credits in the respective accounts held in correspondent banks that accept and distribute the electronic money. The system include a plurality of devices that are used by participants for storing electronic money and for performing money transactions with on-line systems of the participating banks or for exchanging electronic-money with other like transaction devices in off-line transactions. The electronic currency is issued and signed by the Currency Issuing Authority and distributed by the participating banks Each payment exchange of the electronic currency note adds additional digital signature on the electronic currency note and new certificate is added comprising a certificate chain. The system includes data communications means for providing communications services to all components of the system; and security arrangement and verification means for maintaining the integrity of the system, and for detecting counterfeiting and tampering within the system.

As said, the electronic currency of the invention can be used in any way, for electronic commerce, whether by means of an electronic wallet or purse carried by the owner, or in remote e-commerce carried out over communication lines, such as cellular telephone systems or any other line of communication over which e-commerce can be effected, the most important example of which is the Internet e-commerce.

Throughout this specification, when reference is made to the Internet as the e-commerce system, it is meant to indicate any other communication method or system over which e-commerce can be effected, and the description to follow applies mutatis mutandis to any such communication method and system. The Internet is used here for the sake of illustration, it being understood that the invention is not limited to it, or to any other particular system. Furthermore, when reference is made to a network, it may also refer to mixed networks, e.g., where two different networks cooperate in the communication system, such as may be a cooperation of the Internet with a cellular phone system, via an appropriate interface that will be easily appreciated by the skilled person.

All the above and other characteristics and advantages of the invention will be better understood through the following illustrative and non-limitative description of preferred embodiments thereof.

### BRIEF DESCRIPTION OF THE DRAWINGS

FIG. 1 is a schematic representation of electronic cash issuance transaction involving electronic currency, according to a preferred embodiment of the invention;

FIG. 2 schematically illustrates a pay process, according to a preferred embodiment of the, by which a payer pays a payee using the issued electronic currency;

FIG. 3 schematically illustrates a continued payment process using the same issued electronic currency, according to a preferred embodiment of the invention, by which a next payer pays the next payee using the electronic currency;

FIG. 4 schematically illustrates a payment verification process using the issued electronic currency, according to a preferred embodiment of the invention;

FIG. 5 schematically illustrates a payment fraud process and ways fraud is eliminated, according to the process of the invention;

FIG. 6 schematically illustrates a payment sequence process using the issued electronic currency, according to a preferred embodiment of the invention.

FIG. 7 illustrates a graphic representation of an Issuance/Payment Token as displayed on the Payee and Payer devices, according to a preferred embodiment of the invention.

### DETAILED DESCRIPTION OF PREFERRED EMBODIMENTS

In the context of the present invention, the terms “Issuance Token” and “Payment Token” and “electronic cash” and “electronic currency”, as well as “Internet money” and “Internet currency”, are used interchangeably.

In the context of the present invention, the terms “Payer” and “Participant”, are used interchangeably to designate a participant/payer that pays with Payment Token.

In the context of the present invention, the terms “Payee” and “Participant Payee”, are used interchangeably to designate a participant payee that get paid with Payment Token.

The system of the invention will now be described in detail, and will be referred to herein as “The System”, for the sake of brevity. It resembles in many features the monetary system of a country, in which there is a currency issuing authority (CIA) that issues currency (bills, coins or money orders) to individuals. The CIA is based on distributed servers where issued currency tokens can be exchanged for a funding transaction from a participating bank.

The CIA is not involved in the transactions carried out with the currency it issued, but is responsible for the value of the currency and for its maintenance. The CIA continuously examines the currency circulating on the market, replaces Payment Tokens, issues new currency Tokens as needed, and refuses to honor counterfeit currency.

According to The System, a CIA also exists, which functions in a similar manner, but with many improvements and with the differences that will be explained in detail below. The CIA may be a country or an organization within it, or a financial or other organization. As with the treasury of a country, the basic condition for a currency to be of value is the solvency of the CIA or of the organization it represents. There is no limitation on the number of CIAs that may issue electronic currency, and just as with countries, exchange rates can be established between different currencies issued by different CIAs. A CIA may be electronically connected with multiple of financial organizations where issuance of electronic currency could be delivered to be distributed to the participants of the system via the financial organizations.

The Payment Tokens (electronic money) exchanged by the different participants of the System may be an electronic representation of currency or credit. An important aspect of the Payment Tokens is that it is the equivalent of bank notes and is interchangeable with conventional paper money through claims on deposits in an issuing bank, but can be withdrawn or deposited both at an issuing CIA and at a correspondent bank. However, only the issuing CIA through its affiliated banks can generate the Payment Tokens, and will be liable for its redemption.

The issuing banks later utilize inter-bank clearing and settling processes to maintain the monetary balance in the banking system, as is currently practiced by today's banking industry.

The electronic money representations are fungible, universally accepted, and undeniably redeemable from the issuing banks, i.e., they have the characteristics of money transactions. To preserve the integrity of the electronic monetary system, each exchange of electronic money includes, along with other information, data identifying the monetary unit of the credit or currency, (i.e., dollars, yen, etc.) the amount by unit of credit or currency, and several digital signatures.

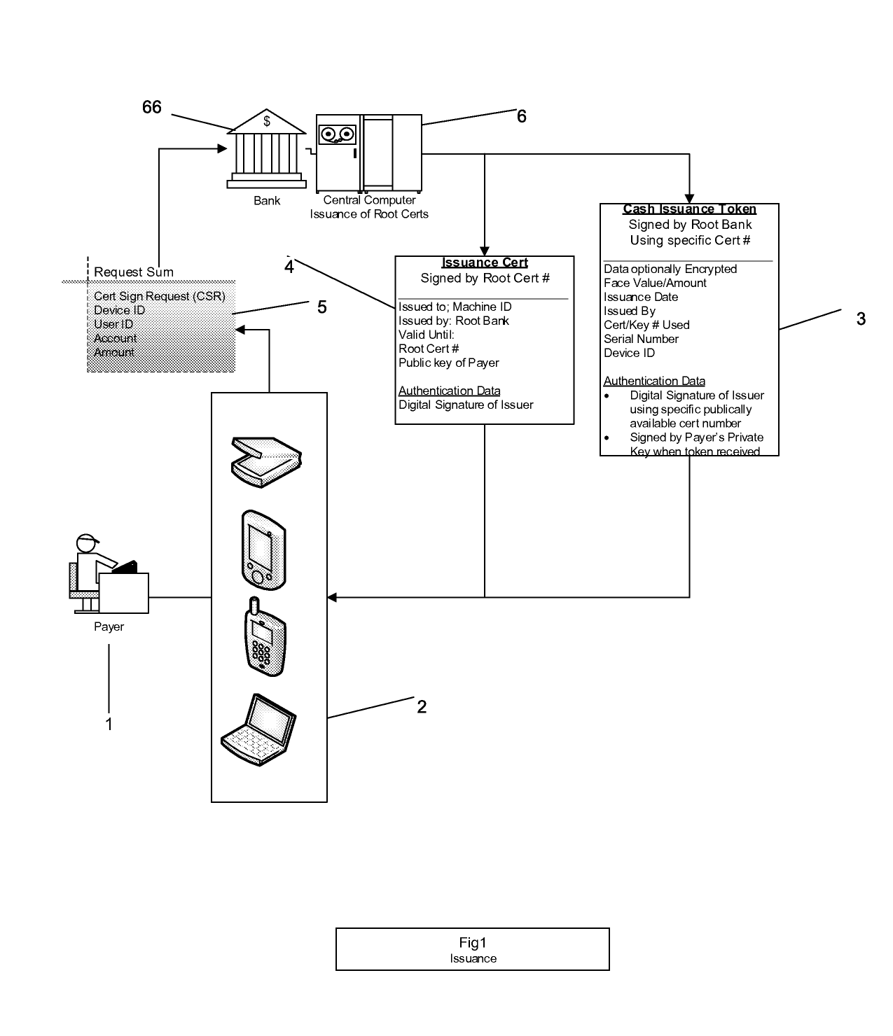

FIG. 1 shows an exemplary description of preferred embodiment for electronic currency issuance of The System. According to the preferred embodiment of The System a Payer-participant 1 requests Issuance Token 6 from the CIA 6 directly or through a Financial Organization/Bank 66. The Payer 1 submits a request using one of the following requesting payer devices 2.
1. PDA
2. Laptop
3. Computer or LAN computer
4. Portable Device
5. Portable Phone
6. Printed Form
7. Internet application

The request 5 submitted directly to the CIA 6 or through the Bank 66 includes the following data items:
1. Certificate request known in the field as CSR, based on a specific private key to be associated with the issuance tokens.
2. The device ID.
3. Account Number.
4. Amount of issuance.
5. Other optional data including user ID, bank ID, Account and routing bank funding information and other data fields used to fund the issuance payment token.

When the CIA gets a confirmation from the participants' banks 66 for the funding of the request, the CIA issues Cash Issuance Tokens 3 consisting of electronic information, which, according to a preferred embodiment of the invention consists of the following:
1. CIA Server Name: Identifies a Cash Issuance server or root bank (e.g. federal reserve)
2. Issuance Date: Cash Issuance Token 3 date of issuance.
3. Expiry Date: Limits the time period of the validity Cash Issuance Tokens 3.
4. Serial Number: Uniquely identifies the Cash Issuance Token.
5. Cash Issuance Value: Amount of face value.
6. Device ID: The Payer 1 device ID to which the Cash Issuance token was issued to.
7. Cert/key#: The Root Authorization Certificate number used to sign the Cash Issuance Token 3.

In addition to the Cash Issuance Tokens the CIA issues an Issuance Certificate 4 which is issued to the Payer and the device ID he used to store the Cash Issuance Tokens 3.

The CIA also issues Issuance Certificate 4 consisting of electronic information, which, according to a preferred embodiment of the invention consists of the following:
1. CIA Server Name: Identifies a Cash Issuance server or root bank.
2. Expiry Date: Limits the time period of the validity.
3. Public Key: the public key of the Payer 1
4. Device ID: The Payer 1 device ID to which the Cash Issuance token was issued to.

5. Cert/key#: The Root Authorization Certificate number used to sign the Cash Issuance Token 3 and the Issuance Certificate 4.

The Issuance Certificate 4 is used by the Payer 1 in the time a payment transaction takes place. The Cash Issuance Token 3 and the Issuance Certificate 4 could be composed as one digital data unit. However, they are described as two separate logical entities for the purpose of clarity.

The Cash Issuance Token 3 is signed with one of the CIA private keys which specific serial number is a data element of the electronic information of the Cash Issuance Token. The corresponding CIA public keys are published as CIA certificates distributed to all participants of the system and are available to any participant. The CIA publishes all the certificates used for Cash Issuance and any new root certificates it generates it distributes to the participants.

The CIA server keeps track of the serial numbers of all outstanding the Cash Issuance Tokens within the system. The Cash Issuance Tokens are digitally signed by the bank using a specific Root Authorization Certificate number. Each Cash Issuance Token has a serial number which is entered into the CIA database when the Cash Issuance Token is generated. When a Payer 1 receives the Cash Issuance Tokens into one of his devices 2, the software on his device signs the Cash Issuance Token with his individual issuance certificate (his private key). At this state the Cash Issuance Token will be digitally signed both by the Payer 1 and by the CIA 6.

It should be noted that the system participants consists of payers-buyers, payees-merchants, Banks and CIA servers. The CIA servers are used only at the time of issuance and for purpose of verification of authenticity and validity of circulating Cash Issuance Tokens.

The Issuance Cert 4 and the Cash Issuance Tokens 3 can be transmitted, received and stored in the payers' devices 2 as one data unit. This data unit, can be provided in any suitable form, e.g., in magnetic form, such as on a diskette, or in optical form, e.g., on a CD-ROM, or can be transferred to the user via electronic mail or other communication method. Thus, there is no limitation whatsoever to the channel through which the electronic currency can be provided.

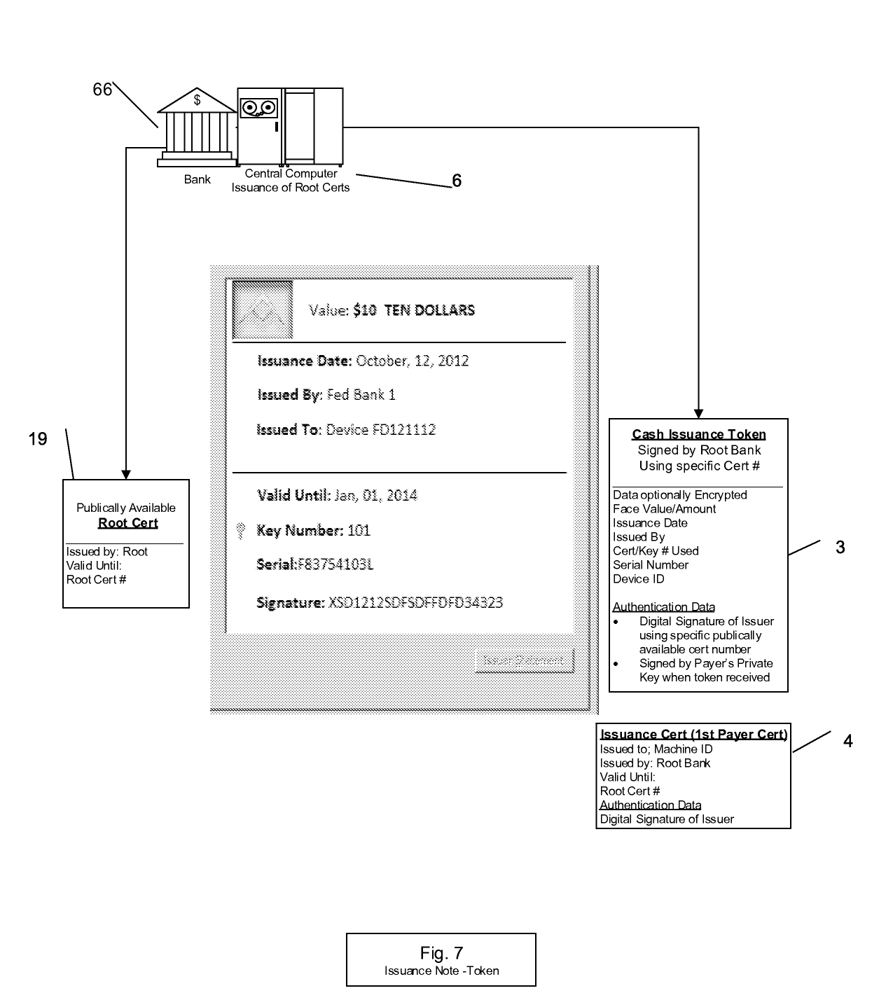

According to a preferred embodiment of The System, the payers' devices 2 will be installed with software, which will be termed hereinafter “Software”, the purpose of which will become apparent from the description to follow. Alternatively, the Software can be provided to the Payer 1 from any other source, such as by downloading it from the Internet. The Software provided to the payer's devices 2, is used according to a preferred embodiment of The System, to allow access to a remote CIA server and to gain access to storage area of the payers' devices 2. The Software not only assists the process in facilitating the access of the CIA server by executing appropriate communication protocols, but may also be provided with security means that prevent fraudulent activities. The Software can further function as the program that actually cooperates in the transfer of the Cash Issuance Tokens from the payer to the payee, the provider of services or goods. The software can also display on the participants' devices the Payment Tokens and some of its data elements in a graphical representation as depicted in FIG. 7.

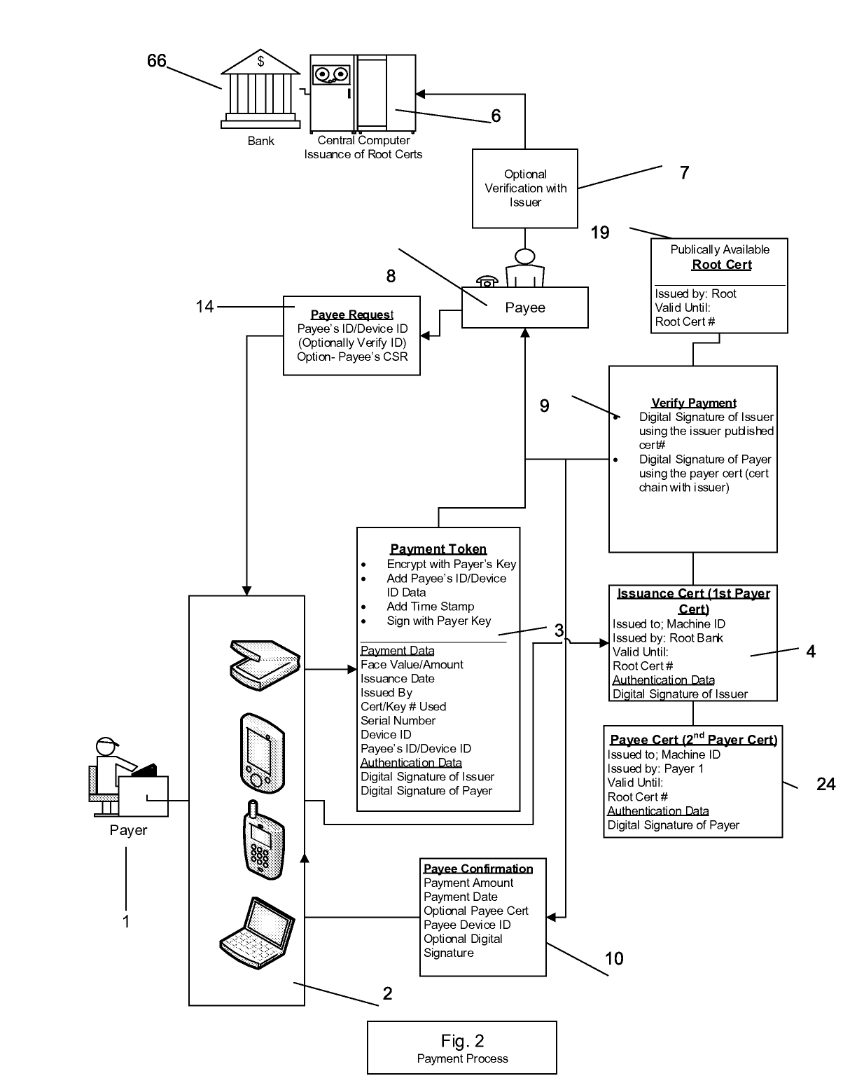

FIG. 2 schematically illustrates a payment process, according to a preferred embodiment of the, by which a Payer 1 pays a Payee 8 using the issued Cash Issuance Token. A Payer 1, interacts with a Payee 8, using one of the Payer Devices 2, via the Internet or other wireless or wired communication methods as blue tooth or any short range wireless methods. When a transaction has been decided upon, and the time comes to effect actual payment, the Payee 8 “effects payment”, by sending a Payment Request 14. Payments Request 14 include the Payee's device ID and/or the Payee's ID, the payment amount and a CSR which is a request to get a signed public key known in the field as a certificate. Upon receipt of the payment Request 14 of Payee 8 to pay a given sum to the Payee, the Payer Devices 2 sends to the Payee 8 the Payment Token 3 and the Issuance Certificate 4 and a newly generated Payee Certificate 24. The newly generated Payee Certificate is based on the CSR sent on the Payee's request 14 and corresponds to a matching private key stored in the Payee's device.

The communication between the payee and the payers' devices is done using the incorporated Software. According to a preferred embodiment of The System, the payers' devices 2 will be installed with software, which will be termed hereinafter “Software”. The Software provided to the payer's devices 2, is used according to a preferred embodiment of The System, to allow access to a remote CIA server and to gain access to storage area of the payers' devices 2. The Software not only assists the process in facilitating the access of the CIA server by executing appropriate communication protocols, but may also be provided with security means that prevent fraudulent activities. The Software can further function as the program that actually cooperates in the transfer of the Cash Issuance Tokens from the Payer to the Payee, the provider of services or goods. The Software facilitates the communication between the Payer and the Payee's devices and manages the transmission of the Payment Token, the Issuance Cert and the Payee's Cert. Furthermore, the software generates the Payer Cert and signs it and marks the Issuance Token as used and optionally deletes the Cash Issuance Token from the data storage.

The Software installed in the Payee's devices receives the data packets sent by the Payer and now examines the data packets which together provide the payment, and then verifies their authenticity. The software uses the CIA published certificate and the Payer's Certificate to verify the authenticity and validity of the data of Payment Token 3. The Payee optionally can further verify the Payment Token through the CIA using communication means via the Internet as depicted in 7. The CIA can provide authenticity information to the payer based on the serial number and the payer's device ID of stored as data elements in the Payment Token. However, the published CIA root certificates 19 and the Payer's Cert 4 are sufficient to validate the payment. When a Payee deposits the Payment Token into his bank account or directly to the CIA the issued Payment Token is removed from circulation and any further deposits of the same Payment Token will indicate a fraud.

Alternatively, of course, the Software transfers the Payment Tokens when the Payee chooses to, to the CIA or to the Payee's bank account and deals with the steps of marking the Payment Tokens as submitted for deposit. On the other hand, the Payer at anytime can exchange any Payments Tokens for bills or other currency at the Bank of another Payee/merchant. Any other alternative procedure is possible, and many alternative procedures for such Payment Tokens transfers and exchanges can be devised by a skilled person.

According to a preferred embodiment of The System, in order to facilitate record keeping, the Payee's and the Payer's Software writes and stores suitable information on the transactions in a protected data area of the Payers' and Payees' devices 2.

During an issuance of Payment Token or any transaction between the Payer and the Payee, a commission for the service could be charged. Of course, the imposition of a commission will be regulated by predetermined rules between the CIA, the participating Banks and its participants.

As explained above, with each payment transaction the Payee's device Software sends a Payee Confirmation 10 to the Payer. The Payee Confirmation 10 consists of the following data elements:
1. Payment Amount.
2. Payment Date.
3. Payee Device ID: The Payee 8 device ID.
4. Payee's Cert/key#: Optional Payee's Certificate used to sign the Payment Confirmation.

When the Payee's confirmation is received by the Payer's Device 2 the Software on the device removes the Payment Token from its storage area and marks it as used. The Software then can record additional information concerning the transaction, the identity and Device ID of the Payee to which the Payment Token has been transferred, the date and time of the transaction, etc., as already explained above. This may be convenient for the purpose of record keeping.

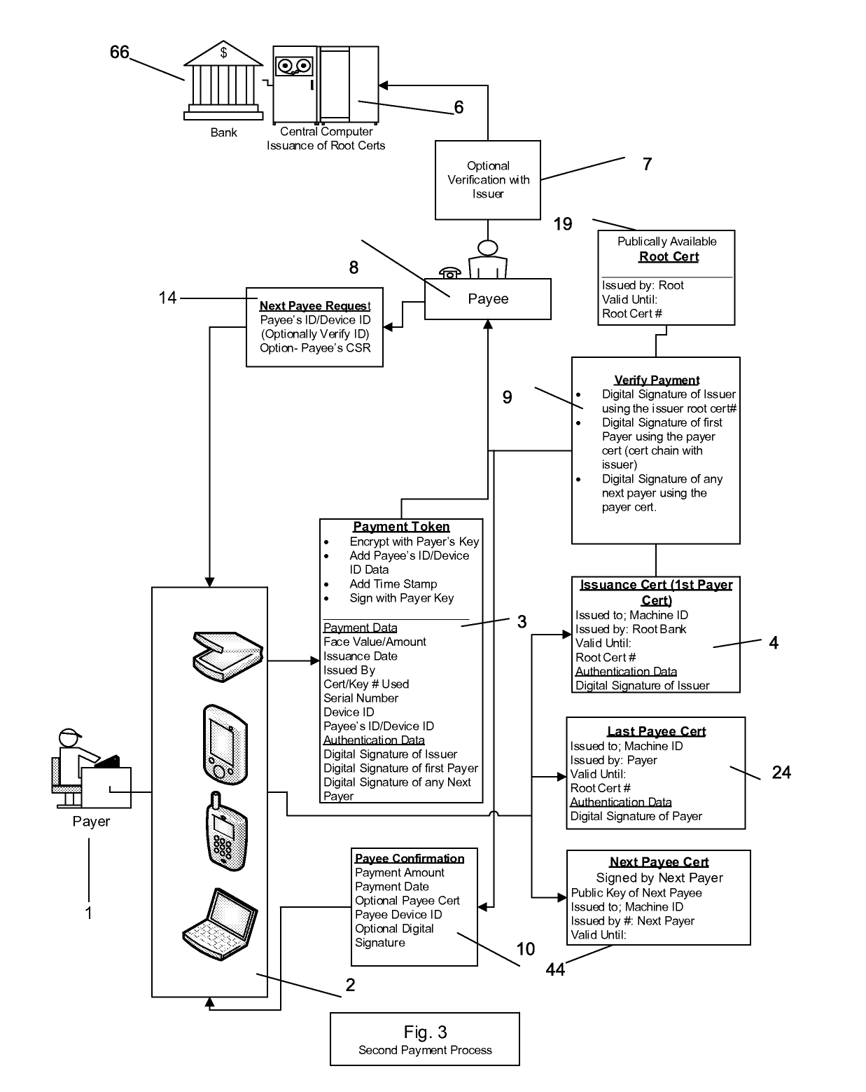

FIG. 3 schematically illustrates a continued payment process using the same issued electronic currency, according to a preferred embodiment of the invention, by which a Next Payer 11 pays the next Payee 8 using the Payment Tokens. A Next Payer 21, interacts with a Next Payee 8, using one of the Payer's Devices 2, via the Internet or other wireless or wired communication methods as blue tooth or any short range wireless methods. When a transaction has been decided upon, and the time comes to effect actual payment, the Payee 8 “effects payment”, by sending a Payment Request 14. Payments Request 14 include the Next Payee's device ID and/or the Next Payee's ID, the payment amount and a CSR which is a request to get a signed public key known in the field as a certificate. Upon receipt of the Payment Request 14 of Next Payer 11 to pay a given sum to the Next Payee 11, the Next Payer Devices 2 sends to the Next Payee 8 the Payment Token 3, Issuance Certificate 4, Last Payee Cert 24 that identifies the last transaction and a newly generated Next Payee Certificate 44. The newly generated Payee Certificate is based on the CSR sent on the Next Payee's request 14 and corresponds to a matching private key stored in the Next Payee's device.

The communication between the payees' and the payers' devices is done using the incorporated Software. According to a preferred embodiment of The System, the Payers' Devices 2 will be installed with software, which will be termed hereinafter “Software”. The Software provided to the Next Payer's devices 2, is used according to a preferred embodiment of The System, to allow access to a remote CIA server and to gain access to storage area of the Next Payers' devices 2. The Software not only assists the process in facilitating the access of the CIA server by executing appropriate communication protocols, but may also be provided with security means that prevent fraudulent activities. The Software can further function as the program that actually cooperates in the transfer of the Payment Tokens 3 from the next Payer to the Next Payee, the provider of services or goods. The Software facilitates the communication between the Next Payer and the Next Payee's devices and manages the transmission of the payment Token, the Issuance Cert and the Payee's Cert. Furthermore, the software generates the Next Payer Cert and signs it and marks the Payment Token as used and optionally deletes the Payment Token from the data storage.

The Software installed in the Next Payee's devices receives the data packets sent by the Next Payer and now examines the data packets which together provide the payment, and verifies their authenticity. The software uses the CIA published certificate and the Payer's certificate to verify the authenticity and validity of the data of Payment Token 3. The Next Payee optionally can further verify the Payment Token through the CIA using communication means via the Internet as depicted in 7. The CIA can provide authenticity information to the Next Payee based on the serial number and the payer's device ID of stored as data elements in the Payment Token.

However, the published CIA root certificates 19 and the payer's cert 4 are sufficient to validate the payment. When a payee deposits the Payment Token into his bank account or directly to the CIA the issued Payment Token is removed from circulation and any further deposits of the same Payment Token will indicate fraud.

Alternatively, of course, the Software transfers the Payment Tokens when the Payee chooses to, to the CIA or to the Payee's bank account and deals with the steps of marking the Payment Tokens as submitted for deposit. On the other hand, the Payer at anytime can exchange any Payments Tokens for bills or other currency at the Bank of another Payee/merchant. Any other alternative procedure is possible, and many alternative procedures for such Payment Tokens transfers and exchanges can be devised by a skilled person.

According to a preferred embodiment of The System, in order to facilitate record keeping, the Next Payee's and the Next Payer's Software writes and stores suitable information on the transactions in a protected data area of the Next Payers' and Next Payees' devices 2. The software can also graphically display the Payment Tokens as depicted on FIG. 7.

During an issuance of Payment Token or any transaction between the Next Payer and the Next Payee, a commission for the service could be charged. Of course, the imposition of a commission will be regulated by predetermined rules between the CIA, the Banks and its participants.

As explained above, with each payment transaction the Next Payee's device Software sends a Next Payee Confirmation 10 to the Next Payer. The Payee Confirmation 10 consists of the following data elements:
1. Payment Amount.
2. Payment Date.
3. Payee Device ID: The Payee 8 device ID.
4. Payee's Cert/key#: Optional Payee's Certificate used to sign the Payment Confirmation

When the Next Payee's confirmation is received by the Next Payer's device 2 the Software on the device removes the Payment Token from it storage area and marked it as used. The Software then can record additional information concerning the transaction, the identity and Device ID of the Payee to which the Payment Token has been transferred, the date and time of the transaction, etc., as already explained above. This may be convenient for the purpose of record keeping.

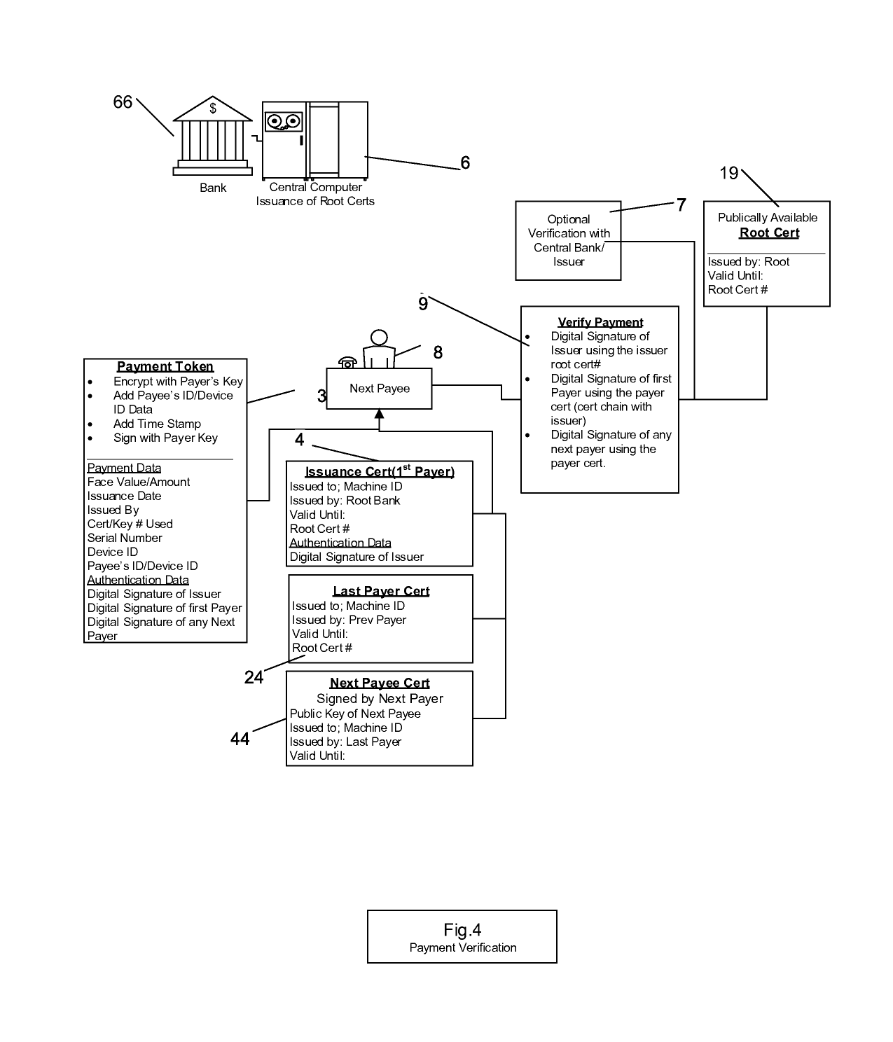

FIG. 4 schematically illustrates a payment verification process using the issued electronic currency, according to a preferred embodiment of the invention. The Software installed in the Payee's devices receives the data packets sent by the Payer and now examines the data packets which together provide the payment, and verifies their authenticity. The data packets include the Payment Token 3, and a certificate chain that include the Issuance Cert 4, the Last Payer Cert 24 and the current Payee Cert 44. The software uses the CIA published certificate 19 and the Payer's certificate chain provided during the payment to verify the authenticity and validity of the data of Payment Token 3 and its digital signatures. The Software uses the Certificate chain to validate the digital signatures on the Payment Token 3. The Software can also validate the device id/machine id chain and its corresponding signed certificates. The Software also verifies the next Payee Cert 44 that is generated and provided by the Payee to be used for the next payment transaction by the Next Payee 8, who becomes Next Payer on the next payment transaction. The Payee optionally can further verify the Payment Token 3 through the CIA using communication means via the Internet as depicted in 7. The CIA can provide authenticity information to the payer based on the serial number and the payer's device ID of stored as data elements in the Payment Token. However, the published CIA root certificates 19 and the payers' certificate chain are sufficient to validate the payment. When a payee deposits the Payment Token 3 into his bank account or directly to the CIA the issued Payment Token is removed from circulation and any further deposits of the same Payment Token will indicate fraud.

Alternatively, of course, the Software transfers the Payment Tokens when the Payee chooses to, to the CIA or to the Payee's bank account and deals with the steps of marking the Payment Tokens as submitted for deposit. On the other hand, the Payer at anytime can exchange any Payments Tokens for bills or other currency at the Bank of another Payee/merchant. Any other alternative procedure is possible, and many alternative procedures for such Payment Tokens transfers and exchanges can be devised by a skilled person.

The data block sent between the Payer and the Payee devices include the Payment Token 3, and a certificate chain that consists of the Issuance Cert 4, the Last Payer Cert 24 and the current Payee Cert 44. The data block in this specification is separated as different logical functional items and can be organized as one data block by any skilled person.

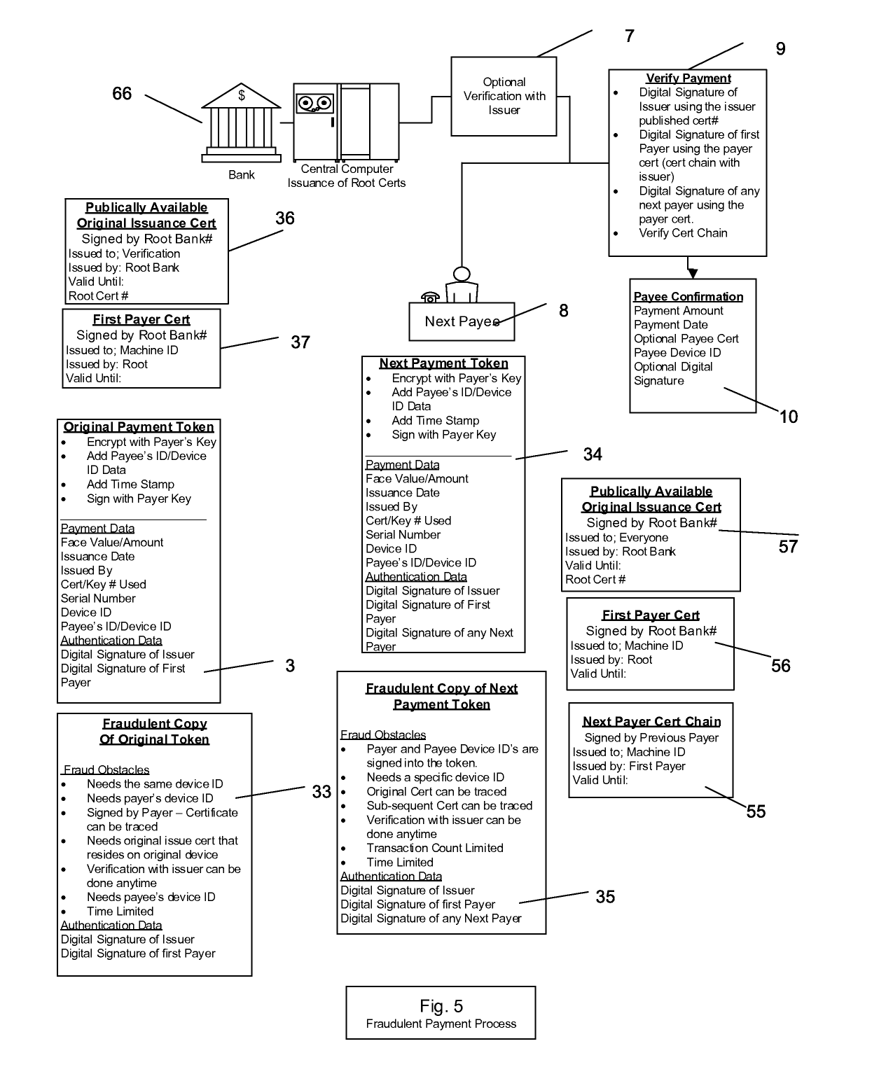

FIG. 5 schematically illustrates a payment fraud process and ways fraud is eliminated, according to the process of this invention. Let us examine what an electronic thief can do in the system exemplified above. He can copy the Issuance Token 3. However, he cannot use it on another device. The issuance can be traced and he needs a Payee Device Id to be signed together with the Issuance Token. A Payee at anytime can verify the Issuance Token with the CIA. Furthermore, expensive devices are needed to propagate the fraud and once fraud is detected from a specific device this device will be a “suspect’ and the CIA will not issue any currency or provide currency for any future submitted Payment Tokens. In addition the Payment Tokens are time limited and removed from circulation by a specific date. In addition, the CIA issues new Root Certificates for new issuance of electronic currency. The root certificates useful period of existence limits the ability to propagate fraud as devices are needed to be customized for each attempt of fraud and the fraud can be traced to the originator. The device Id and other information signed into the Payment Token helps control any abuse and fraud.

Electronic thief can try to construct a device with changeable device IDs. However, the Issuance Tokens are issued to specific device and the electronic thief will need to construct multiple devices which will not be cost effective to him. Furthermore, the Software in these devices will need to be constructed in order to propagate the fraud. However, the software is provided by the CIA and its source is not publically available and the code of the software will be highly guarded and protected like any other financial software. In a case that a fraudulent Payment Token circulates, the CIA can verify the serial number of the Issuance Token. If the token's serial number is fraudulent or out of circulation the CIA could digitally analyze the fraudulent token and its signatures and trace the fraudulent Device ID.

Another main protection, however, lies in that the sums of money involved will typically be small. Internet users will usually not purchase motorcars using Internet money, since there are better and safer ways to effect transactions involving large amounts of money. Most purchases over the Internet or in retail stores range between a few dollars to a few tens of dollars, or even above one hundred dollars. Since the amounts of money involved in the transactions are very small, and, when operating according to the invention, the difficulty in organizing a theft is very great, there is no real incentive for theft, since no rewarding amounts can be stolen.

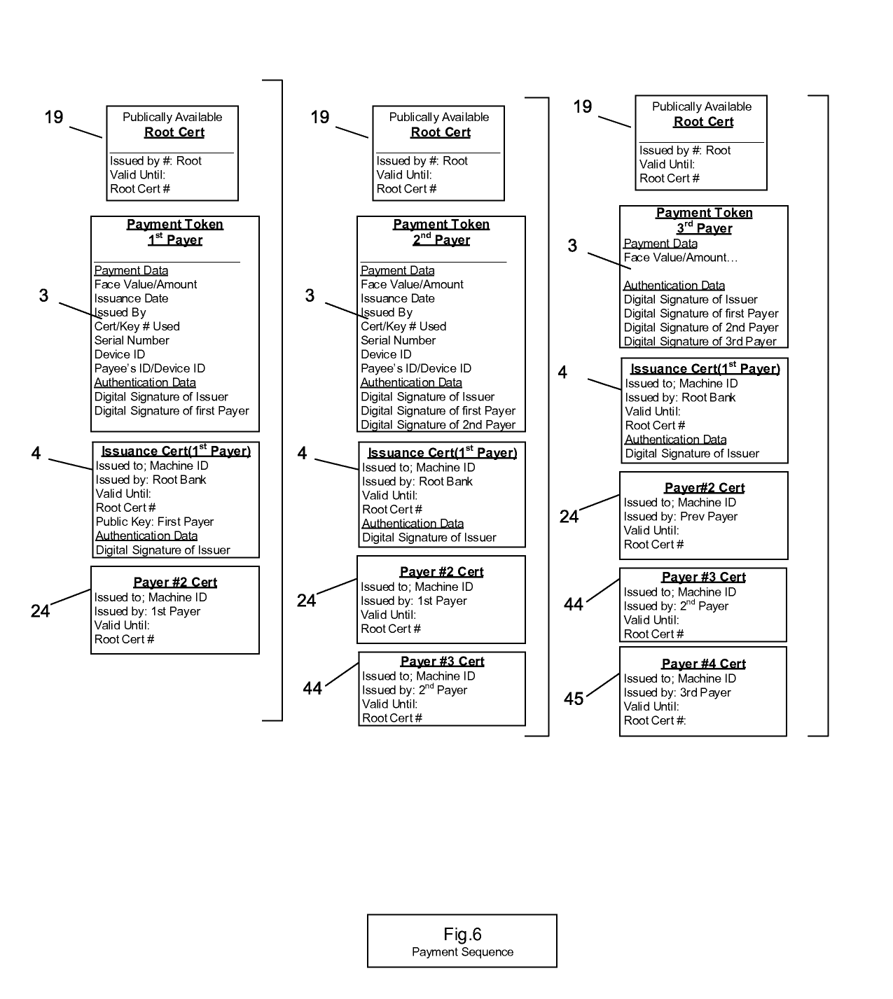

FIG. 6 schematically illustrates a continued payment sequence depicting the digital data content transferred between a payer and a payee, in block diagram. When a transaction has been decided upon, and the time comes to effect actual payment, the Payee “effects payment” by sending a Payment Request. Upon receipt of the Payment Request of the Payer to pay a given sum to the Payee, the Payer sends to the Payee the Payment Token 3, Issuance Certificate 4 and the Last Payee Cert 24 that identifies the last transaction. The next payment sequence will include a newly generated Next Payee Certificate 44. The newly generated Payee Certificate is based on a CSR sent on the Next Payee's request and corresponds to a matching private key stored in the Next Payee's device. Each next Payer will generate a new Payer Cert to be used in the next payment transaction 44, 45.

The communication between the payees' and the payers' devices is done using the incorporated Software. According to a preferred embodiment of The System, the payers' devices will be installed with software, which will be termed hereinafter “Software”. The Software provided, is used according to a preferred embodiment of The System, to allow access to a remote CIA server and to gain access to storage area of the Payers' devices and communicate with the Payee devices. The Software facilitates the communication between the Payer and the Payee's devices and manages the transmission of the Payment Token, the Issuance Cert and the Payee's cert. Furthermore the software generates the Next Payer Cert and signs it and marks the Payment Token as used and optionally deletes the Payment Token from the data storage.

The Software installed in the Next Payee's devices receives the data packets sent by the Next Payer and now examines the data packets which together provide the payment, and verifies their authenticity. The software uses the CIA published certificate and the Payer's certificate to verify the authenticity and validity of the data of Payment Token The Payee optionally can further verify the Payment Token through the CIA using communication means via the Internet. The CIA can provide authenticity information to the Next Payee based on the serial number and the payer's device ID of stored as data elements in the Payment Token. However, the published CIA root certificates 19 and the Payer's Cert 4 are sufficient to validate the payment. When a payee deposits the Payment Token into his bank account or directly to the CIA the issued Payment Token is removed from circulation and any further deposits of the same Payment Token will indicate fraud.

While embodiments of the invention have been described by way of illustration, it will be understood that the invention can be carried out by persons skilled in the art with many modifications, variations and adaptations, without departing from its spirit or exceeding the scope of the claims. For instance, other networks can be used instead of the Internet, many different data manipulation methods and procedures can be devised, and many different programs, security means and accessories can be used, all without exceeding the scope of the invention.

1. A method for handling electronic currency transactions between participants comprising:
(a) providing a plurality of Currency Issuing Authorities, each Currency Issuing Authority issuing a plurality of Root Authorization Certificates;
(b) issuing the Root Authorization Certificates to a plurality of participants, each of the plurality of participants including a computer system;
(c) a first participant requesting Electronic Cash Notes;
(d) issuing a plurality of Electronic Cash Notes to the first participant, said Electronic Cash Notes being signed using one of the said Root Authorization Certificates, and each Electronic Cash Note comprising
(i) information suitable to verify that the Electronic Cash Note has been issued by an Currency Issuing Authority,
(ii) information on its value,
(iii) information on the identity of the Electronic Cash Note,
(iv) information on a denomination value,
(v) information on the first participant, and
(vi) information on the first participant device;
(e) transmitting the requested Electronic Cash Notes to the first participant;
(f) the first participant receiving a Request for Payment from a second participant, the Request for Payment comprising information suitable to identify the second participant;
(g) the first participant signing one or more Electronic Cash Notes and the Request for Payment data submitted by the second participant, using a digital certificate stored in the first participant device;
(h) the first participant transmitting the signed Electronic Cash Notes and the a first participant digital certificate and the signed Request for Payment to the second requesting participant;
(i) the second participant receiving the Electronic Cash Notes and signed Request for Payment data from the first requesting participant; and
(j) the second participant verifying the Electronic Cash Notes using the first participant digital certificate and the Root Authorization Certificates, wherein verifying includes
(i) receiving the first participant digital certificate and Root Authorization Certificate, and
(ii) verifying the digital signatures of the Electronic Cash Notes.
(k) the second participant receiving a Request for Payment from a third participant, the Request for Payment comprising information suitable to identify the third participant;
(l) the second participant signing one or more Electronic Cash Notes and the Request for Payment data submitted by the third participant, using a digital certificate stored in the second participant device;
(m) the second participant transmitting the signed Electronic Cash Notes and the a first and second participant digital certificates and the signed Request for Payment to the third requesting participant;
(n) the third participant receiving the Electronic Cash Notes and signed Request for Payment data from the second participant; and
(o) the third participant verifying the Electronic Cash Notes using the first and the second participants digital certificates and the Root Authorization Certificates, wherein verifying includes
(i) receiving the first and second participants digital certificate and Root Authorization Certificate, and
(ii) verifying the digital signatures of the Electronic Cash Notes.

2. The method of claim 1, further comprising applying at least one digital timestamp to the Digital Signatures, wherein the digital timestamp is used to validate the Digital Signatures.

3. The method of claim 1, further comprising applying at least one digital timestamp to the Electronic Cash Note, wherein the digital timestamp is used to validate the Electronic Cash Note.

4. The method of claim 1, wherein the Electronic Cash Note and the said Certificates and/or the Request for Payment are comprised together consisting of a single data stream.

5. A method for transferring information between participant devices in a system according to claim 1, the method comprising:
(a) creating a request message which includes information related to the participant device;
(b) requesting a transfer of Electronic Cash Notes;
(c) storing the Electronic Cash Notes in an intermediary storage;
(d) checking whether Electronic Cash Notes handling software has been implemented in said participant device;
(e) receiving a code verifying that the intended participant device is authorized to receive the Electronic Cash Notes; and
(f) transferring the Electronic Cash Notes to the participant device.
(g) transferring the said certificates to the participant device.

6. The method of claim 1, wherein Root Authorization Certificates and the said participant Certificates are comprised of public keys and the said Electronic Cash Notes are signed by the respective private keys.

7. A system for handling electronic currency transactions between participant devices and/or entities comprising:
(a) a Plurality of Currency Issuing Authorities, each Currency Issuing Authority issuing a plurality of Root Authorization Certificates to a plurality of participants, each of the plurality of participants including a computer system;
(b) means for issuing a plurality of Electronic Cash Notes to participants requesting the Electronic Cash Notes, each Electronic Cash Note being signed using one of the said Root Authorization Certificates and comprising
(i) information suitable to verify that the Electronic Cash Note has been issued by an Currency Issuing Authority,
(ii) information on its value,
(iii) information on the identity of the Electronic Cash Note,
(iv) information on a denomination value,
(v) information on the requesting participant,
(vi) information on the participant device,
(c) means for transmitting the Electronic Cash Notes to the requesting participants;
(d) means for receiving Requests for Payment from participants, each request comprising suitable information to identify the participant requesting payment;
(e) means for signing the Electronic Cash Notes and the Request for Payment data submitted by the participants using a certificate stored in the participant device;
(f) means for transmitting the signed Electronic Cash Notes and the Request for Payment data and the participants certificates to the requesting participant;
(g) means for verifying the Electronic Cash Notes using the participants certificate that singed the electronic Cash Notes and the Root Authorization Certificates; wherein verifying includes
(i) receiving the participants certificates and Root Authorization Certificate, and
(ii) verifying the digital signatures of the Electronic Cash Notes and the signed Payment data.

8. The system of claim 7, further comprising means for applying at least one digital timestamp to the said Digital Signatures, wherein the digital timestamp is used to validate the Digital Signatures.

9. The system of claim 7, further comprising means for applying at least one digital timestamp to the said Electronic Cash Note, wherein the digital timestamp is used to validate the Electronic Cash Note.

10. The system of claim 7, wherein the Electronic Cash Note and the said Certificates and/or the Request for Payment are comprised together consisting of a single data stream.

11. A system for transferring information between participant device and/or entities of a system according to claim 7, the system comprising:
(a) means for creating a cash request message including information related first participant device;
(b) means for requesting a transfer of said Electronic Cash Notes;
(c) means for storing said Electronic Cash Notes in an intermediary storage;
(d) means for checking whether an intended participant device has implemented a Electronic Cash Notes handling software in said participant device;
(e) means for receiving a code verifying that the intended participant device is authorized to receive the Electronic Cash Notes; and
(f) means for transferring the Electronic Cash Notes and certificates to the participant device.

12. A computer-readable electronic storage device, having stored therein a computer-readable Cash Issuance Token issued by a cash issuing server or root bank, the Token comprising:
a) the identity of the issuing server or root bank;
b) a date of issuance of the Token;
c) a time period of the validity, or the expiration date, of the Token;
d) a serial number uniquely identifying the Token;
e) a cash value of the Token;
f) a device ID, identifying the device to which the Token was initially issued; and
g) a root authorization certificate number;
wherein the Token is signed by the root authorization certificate.

13. The Cash Issuance Token of claim 12, further comprising means for applying additional data to the said Cash Issuance Token, wherein the data include:
(a) Ticket information;
(b) Identity information;
(c) Event Information;
(d) Purchase Information;
(e) Personal Data;
(f) Token Value information.
